(19) United States
(12) Patent Application Publication
(10) Pub. No.: US 2025/0382991 A1
(43) Pub. Date: Dec. 18, 2025

(54) JOURNAL BEARING INTERFACE WITH COMPLIANT EDGE EFFECT

(71) Applicant: Jacobs Vehicle Systems, Inc., Bloomfield, CT (US)

(72) Inventors: Matei ALEXANDRU, Simsbury, CT (US); Tao SUN, Avon, CT (US); P. Douglas AUBIN, Glastonbury, CT (US)

(21) Appl. No.: 19/228,641

(22) Filed: Jun. 4, 2025

Related U.S. Application Data
(60) Provisional application No. 63/661,434, filed on Jun. 18, 2024.

(51) Int. Cl. F16C 33/06; F16C 9/04

(52) U.S. Cl. CPC F16C 33/06; F16C 9/04

(57) ABSTRACT

Systems, apparatuses, and methods described in some implementations herein provide for technology for a journal bearing having a relief complaint edge feature. The journal bearing comprising a main body having an inner surface defining a shaft bore and an outer surface positioned at a distance from the inner surface. An end surface extends radially between the inner surface and the outer surface. A relief complaint edge feature is formed at the end surface. The relief complaint edge feature is a relief groove formed in the end surface in some implementations. In other implementations, the relief complaint edge feature is a relief flange formed on the end surface.

### FIELD

The instant disclosure relates generally to systems, apparatuses, and methods for a journal bearing interface. In particular, embodiments of the instant disclosure relate to systems, apparatuses, and methods for a rocker shaft journal bearing interface with a compliant edge effect for reducing edge stress.

### BACKGROUND

In highly loaded journal bearing application, such as for rocker shafts used in internal combustion engines, it is often found that the peak stress occurs at the end (or edge) of the journal bearing. This causes wear issues as the edge acts as a sharp interface where the material contact pressure limit can be exceeded, which may lead to unacceptable wear/behavior. Such wear can potentially erode the edge itself.

In existing solutions, it has been seen that this issue can be addressed with complicated surface machining. For example, crowning may be machined into a shaft to force peak pressure to the center. In such an example, an external surface of a roller to a camshaft may be crowned (e.g., to have an increased thickness at a middle portion as compared to edge portions).

Referring now to FIG. 1, a journal bearing 100 having an angled chamfer 102 in accordance with prior art techniques is illustrated. As illustrated, the angled chamfer 102 is formed as a forty five degree cut (or the like) located at an inner ring of an axial end surface of the journal bearing 100. However, such an angled chamfer 102, while better than an unchamfered edge, is typically still subject to unacceptably high stresses at the end of the journal bearing 100. Such unacceptably high stresses typically will peak at the end of the journal bearing 100.

Similarly, crowned machining of the shaft bore may be implemented (e.g., via a fall off radius, a tangential fillet, or a trumpet honing) to force peak pressure to the center.

Referring now to FIG. 2, a journal bearing 200 having a tangential fillet 202 in accordance with prior art techniques is illustrated. Such a tangential fillet 202 is located at an inner ring of an axial end surface of the journal bearing 200. As illustrated, the tangential fillet 202 is formed to have a fall off radius to taper off gradually. Such a tangential fillet 202 permits an edge of a shaft bore to conform when there is a high load causing twisting to the journal bearing 200. However, while performing better than the angled chamfer 102 discussed above, such a tangential fillet 202 is also typically subject to unacceptably high stresses at end of the journal bearing 200. Additionally, such a tangential fillet 202 has a relatively high cost to properly machine.

While a journal bearing 200 having a tangential fillet 202 operates acceptably for its intended purpose for rocker shafts in some circumstances, various improvements thereto would be a welcome addition in the art.

### SUMMARY

Advantageously, some implementations discussed herein allow a journal bearing (such as may be used, for example, in a valvetrain of an internal combustion engine) to have improved capabilities and/or functionality at a cost that is less than other more complex machining options. For example, some implementations discussed herein reduce the effective stiffness of the edge of the journal bearing so that the journal bearing edge deflects such that excessive contact pressures are avoided. Such deflection allows peak stress to migrate into the main body of the journal bearing, typically with much lower levels of stress and/or pressure.

As will be described in greater detail below, in some implementations discussed herein, systems, apparatuses, and methods provide for a relief groove or a relief flange that may be formed in an end surface of the journal bearing. For example, such a relief groove may be located adjacent a corner edge of an end surface of the journal bearing. Similarly, such a relief flange may be located to define a portion of the shaft bore. Such a relief groove or a relief flange may provide a complaint edge effect at a reduced cost in machining and with an improved resistance to stress as compared to a journal bearing having a tangential fillet.

For example, such a relief groove or a relief flange reduces the effective stiffness of the edge of the journal bearing so that it cannot support the pressure at the end surface of the journal bearing and deflects. This defections allows the peak stress to migrate into the main body of the journal bearing, typically with much lower levels of stress/pressure as compared to a journal bearing having a tangential fillet.

In some examples, a journal bearing includes a main body having an inner surface defining a shaft bore and an outer surface positioned at a distance from the inner surface. An end surface extends radially between the inner surface and the outer surface. A relief groove is formed in the end surface.

In other examples, a journal bearing includes a main body having an inner surface defining a shaft bore and an outer surface positioned at a distance from the inner surface. An end surface extends radially between the inner surface and the outer surface. A relief flange is formed on the end surface.

In a further example, a journal bearing for mounting on a shaft includes a main body having an inner surface defining a shaft bore and a lateral end surface extending radially from the inner surface. A relief complaint edge feature is formed at the lateral end surface.

This Summary is provided to introduce a selection of concepts in a simplified form that are further described below in the Detailed Description. The foregoing Summary, as well as the following Detailed Description of certain implementations, will be better understood when read in conjunction with the appended drawings. This Summary is not intended to identify key features or essential features of the claimed subject matter, nor is it intended to be used as an aid in determining the scope of the claimed subject matter.

### BRIEF DESCRIPTION OF THE DRAWINGS

The foregoing and other features and advantages will be discussed in detail in the following non-limiting description of specific embodiments in connection with the accompanying drawings, in which:

FIG. 1 illustrates a cross sectional view of a journal bearing having an angled chamfer in accordance with prior art;

FIG. 2 illustrates a cross sectional view of a journal bearing having a tangential fillet in accordance with prior art;

FIG. 3 illustrates a schematic diagram of a valve train according to an example of the instant disclosure;

FIG. 4 illustrates a cross sectional view of a journal bearing having a relief groove according to an example of the instant disclosure;

FIG. 5 illustrates a cross sectional view of a journal bearing having a relief flange according to an example of the instant disclosure; and

FIG. 6 is a chart illustrating pressure performance for end of journal bearing implementations according to an example of the instant disclosure.

### DETAILED DESCRIPTION OF THE PRESENT EMBODIMENTS

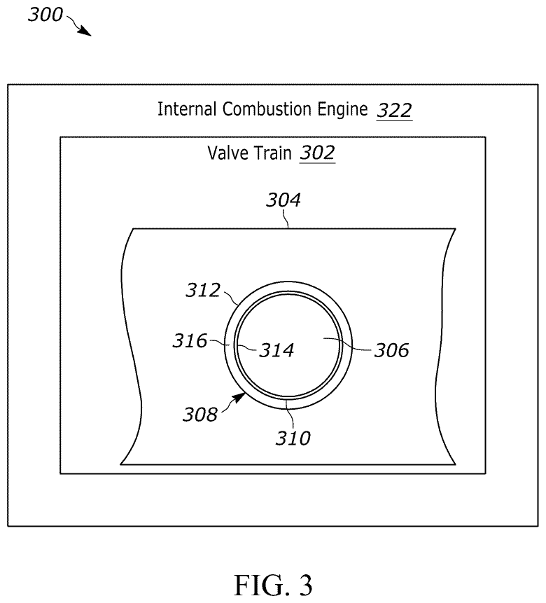

FIG. 3 illustrates a schematic diagram of a valve train 302 according to an example of the instant disclosure. In the illustrated example, the valve train 302 may include a rotating component 304 (e.g., a rocker arm). A shaft 306 (e.g., a rocker shaft) may be disposed within the rotating component 304. A journal bearing 308 may be disposed on the shaft 306 between the shaft 306 and the rotating component 304. As will be described in greater detail below, a relief complaint edge feature 310 (e.g., such as a relief groove or a relief flange) may be formed in the journal bearing 308. It will be appreciated that such a journal bearing 308 having a relief groove or a relief flange may be used for any type of journal bearing 308, and not only for implementations involving a valve train 302.

For example, the journal bearing 308 for mounting on the shaft 306 includes a main body 312 having an inner surface 314 defining a shaft bore and a lateral end surface 316 extending radially from the inner surface 314. The relief complaint edge feature 310 is formed at the lateral end surface 316.

In some examples, the valve train 302 is included in an internal combustion engine 322. In such an example, the rotating component 304 (e.g., a rocker arm) is disposed about the shaft 306 (e.g., a journal of a rocker shaft), and the journal bearing 308 is disposed between the rotating component 304 (e.g., a rocker arm) and the shaft 306 (e.g., a journal of a rocker shaft).

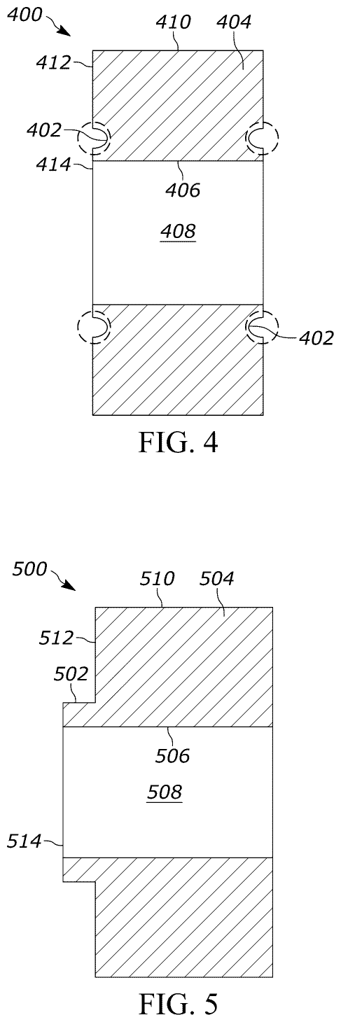

FIG. 4 illustrates a schematic, diametrical cross sectional view of a journal bearing 400 having a pair of relief grooves 402 according to an example of the instant disclosure. In the illustrated implementation, the journal bearing 400 includes a main body 404 having an inner surface 406 defining a shaft bore 408 and an outer surface 410 positioned at a radial distance from the inner surface 406. The journal bearing 400 includes an end surface 412 extending radially between the inner surface 406 and the outer surface 410. The relief groove 402 is formed in the end surface 412. In some implementations, the end surface 412 has a corner edge 414 at a junction with the inner surface 406, where the relief groove 402 is located adjacent the corner edge 414. Although the relief groove 402 is illustrated in conjunction with both end surfaces 412 of the journal bearing 400, it is appreciated that the relief groove 402 may be deployed in conjunction with only a single end surfaces 412 of the journal bearing 400.

In some implementations, the relief groove 402 is sized (e.g., with a target depth and width) to achieve a desired target edge stiffness (e.g., such as a gradient of stiffness across the face of the journal bearing). One of ordinary skill in the art will appreciate that the sizing of the relief groove 402 will change depending on the stiffness of a material used to construct the journal bearing as well as the anticipated peak loads to be placed on the journal bearing.

In some examples, the relief groove 402 has a curved cross-sectional shape as depicted in FIG. 4. For example, the relief groove 402 has a curved shape such as a circular shape, an elliptical shape, a parabolic shape, a hyperbolic shape, and/or the like. It is appreciated, however, that other cross-sectional shapes such as rectangular or V-shaped relief grooves 402 may be equally employed.

In some implementations, the journal bearing 400 is a complete cylinder (e.g., extending a full 360 degrees) and the relief groove 402 extends around an entirety of the shaft bore 408 on the end surface 412 of the journal bearing 400. Referring to FIG. 7, however, in some implementations load is expected to be applied to the journal bearing 400 from only a single direction. In such situations the relief groove 402 and/or the journal bearing 400 itself may be reduced in size to only be located where load is anticipated. For example, where the journal bearing 400 is a complete cylinder, the relief groove 402 may extend across only a portion of the end surface 412 (as is illustrated in FIG. 7). In another example, where the journal bearing 400 is a partial cylinder (e.g., extending less than 360 degrees), the relief groove 402 may extend across an entirety of the end surface 412.

In some examples, the relief groove 402 may be formed via an end mill (e.g., using a ball end) or the like to machine the relief groove into the journal bearing.

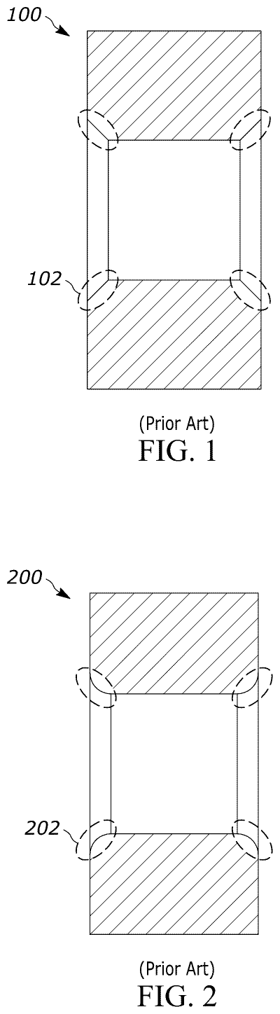

In some implementations, the relief groove 402 may be used in combination with the journal bearing 100 having an angled chamfer (e.g., as illustrated in FIG. 1) or the journal bearing 200 having a tangential fillet (e.g., as illustrated in FIG. 2). However, such combinations will typically be more expensive to manufacture than implementations that only utilize the relief groove 402.

FIG. 5 illustrates a cross sectional view of a journal 500 bearing having a relief flange 502 according to an example of the instant disclosure. In the illustrated implementation, the journal bearing 500 includes a main body 504 having an inner surface 506 defining a shaft bore 508 and an outer surface 510 positioned apart from the inner surface 506. The journal bearing 400 includes an end surface 512 extending radially between the inner surface 506 and the outer surface 510. The relief flange 502 is formed in the end surface 512 and defines a portion of the shaft bore 508. Although the relief flange 502 is illustrated in conjunction with only one end surface 512 of the journal bearing 500, it is appreciated that a similar, oppositely extending flange may be deployed in conjunction with an opposite end surface of the journal bearing 500.

In some implementations, the relief flange 502 is sized (e.g., with a target depth and width) to achieve a desired target edge stiffness (e.g., such as a gradient of stiffness across the face of the journal bearing). One of ordinary skill in the art will appreciate that the sizing of the relief flange 502 will change depending on the stiffness of a material used to construct the journal bearing 500 as well as the anticipated peak loads to be placed on the journal bearing 500.

In some examples, the relief flange 502 has a collar shape extending from the end surface.

In some implementations, the journal bearing 500 is a complete cylinder (e.g., extending a full 360 degrees) and relief flange 502 extends across an entirety of the end surface 512 of the journal bearing 500. However, in some implementations load is expected to be applied to one side of the journal bearing 500. In such situations the relief flange 502 and/or the journal bearing 500 itself may be reduced in size to only be located where load is anticipated. For example, where the journal bearing 500 is a complete cylinder, the relief flange 502 may extend across only a portion of the end surface 512. In another example, where the journal bearing 500 is a partial cylinder (e.g., extending less than 360 degrees), the relief flange 502 may extend across an entirety of the end surface 512.

In some implementations, the relief flange 502 may be formed by casting the relief flange 502 with the journal bearing 500, machining the relief flange 502 out of the journal bearing 500 itself, or the like. In some implementations, the relief flange 502 may be used in combination with the journal bearing 100 having an angled chamfer (e.g., as illustrated in FIG. 1) or the journal bearing 200 having a tangential fillet (e.g., as illustrated in FIG. 2). However, such combinations will typically be more expensive to manufacture than implementations that only utilize the relief flange 502. In such examples, the angled chamfer or tangential fillet will be formed in an inner corner edge 514 of the relief flange 502.

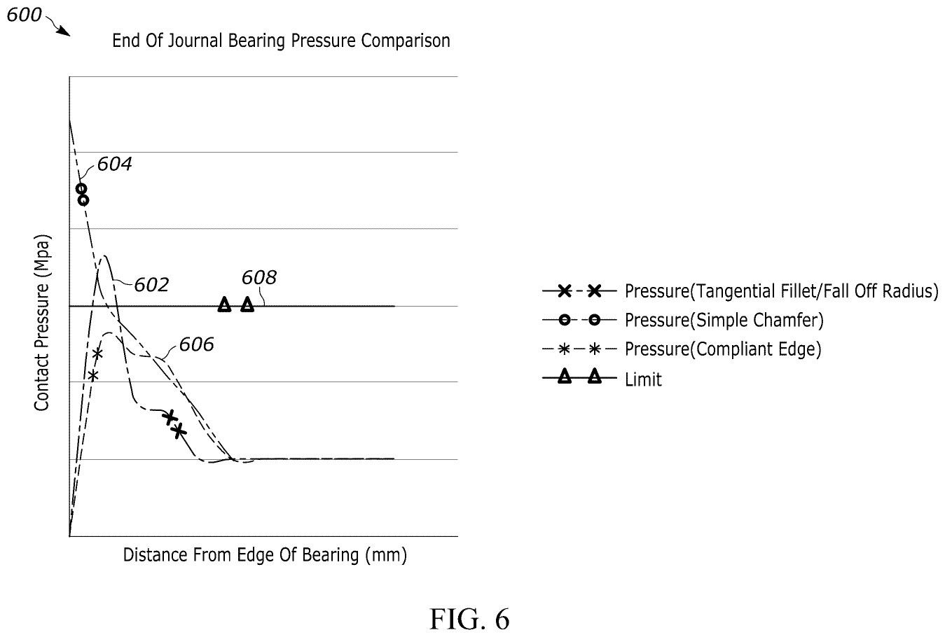

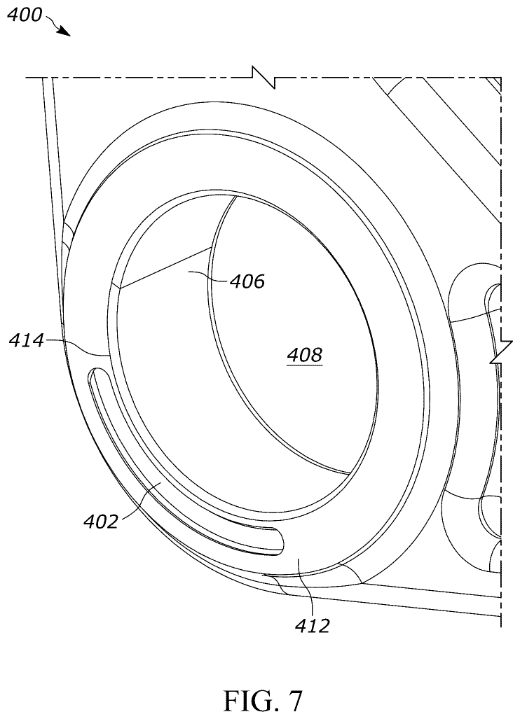

FIG. 6 illustrates a chart 600 illustrating simulated pressure performance for end of journal bearing implementations according to an example of the instant disclosure. The chart illustrates a plot of contact pressure at various distances from an edge of the bearing (at the zero point along the x-axis) for various solutions. As illustrated, an implementation utilizing a relief groove 606 (listed in the chart as “compliant edge”) has an improved pressure profile as compared to the pressure profiles of the “simple chamfer” 604 as well as the “tangential fillet/fall off radius” 602. For example, the pressure profile of the implementation utilizing a relief groove 606 (listed in the chart as “compliant edge”) is the only one to operate below the specified pressure “limit” 608.

### ADDITIONAL NOTES AND EXAMPLES

Clause 1 is a journal bearing, comprising: a main body, the main body having an inner surface defining a shaft bore and an outer surface positioned at a distance from the inner surface; an end surface extending radially between the inner surface and the outer surface; and a relief groove formed in the end surface.

Clause 2 includes the journal bearing of Clause 1, wherein the relief groove has a curved shape.

Clause 3 includes the journal bearing of any one of Clauses 1 to 2, wherein the end surface has a corner edge at a junction with the inner surface, wherein the relief groove is located adjacent the corner edge.

Clause 4 includes the journal bearing of any one of Clauses 1 to 3, wherein the journal bearing is a partial cylinder, and wherein the relief groove extends across an entirety of the end surface.

Clause 5 includes the journal bearing of any one of Clauses 1 to 3, wherein the journal bearing is a complete cylinder, and wherein the relief groove extends across only a portion of the end surface.

Clause 6 is a journal bearing, comprising: a main body, the main body having an inner surface defining a shaft bore and an outer surface positioned at a distance from the inner surface; an end surface extending radially between the inner surface and the outer surface; and a relief flange formed on the end surface.

Clause 7 includes the journal bearing of Clause 6, wherein the relief flange has a collar shape extending from the end surface.

Clause 8 includes the journal bearing of any one of Clauses 6 to 7, wherein the relief flange is located to define a portion of the shaft bore.

Clause 9 includes the journal bearing of any one of Clauses 6 to 7, wherein the journal bearing is a partial cylinder, and wherein the relief flange extends across an entirety of the end surface.

Clause 10 includes the journal bearing of any one of Clauses 6 to 7, wherein the journal bearing is a complete cylinder, and wherein the relief flange extends across only a portion of the end surface.

Clause 11 is a journal bearing for mounting on a shaft, the journal bearing comprising: a main body having an inner surface defining a shaft bore and a lateral end surface extending radially from the inner surface; and a relief complaint edge feature formed at the lateral end surface.

Clause 12 includes the journal bearing of Clause 11, wherein the relief complaint edge feature is a relief groove.

Clause 13 includes the journal bearing of any one of Clauses 11 to 12, wherein the relief groove has a curved shape.

Clause 14 includes the journal bearing of any one of Clauses 11 to 13, wherein the journal bearing is a partial cylinder, and wherein the relief groove extends across an entirety of the lateral end surface.

Clause 15 includes the journal bearing of any one of Clauses 11 to 12, wherein the journal bearing is a complete cylinder, and wherein the relief groove extends across only a portion of the lateral end surface.

Clause 16 includes the journal bearing of Clause 11, wherein the relief complaint edge feature is a relief flange.

Clause 17 includes the journal bearing of Clause 16, wherein the relief flange has a collar shape extending from the lateral end surface.

Clause 18 includes the journal bearing of any one of Clauses 16 to 17, wherein the journal bearing is a partial cylinder, and wherein the relief flange extends across an entirety of the lateral end surface.

Clause 19 includes the journal bearing of any one of Clauses 16 to 17, wherein the journal bearing is a complete cylinder, and wherein the relief flange extends across only a portion of the lateral end surface.

Clause 20 is an internal combustion engine comprising a rocker arm disposed about a journal of a rocker shaft, and further comprising the journal bearing of Clause 11 disposed between the rocker arm and journal.

Clause 21 includes an apparatus including means for performing the function of any preceding Clause.

All definitions, as defined and used herein, should be understood to control over dictionary definitions, definitions in documents incorporated by reference, and/or ordinary meanings of the defined terms.

As used herein, phrases substantially similar to “at least one of A, B or C” are intended to be interpreted in the disjunctive, i.e., to require A or B or C or any combination thereof unless stated or implied by context otherwise. Further, phrases substantially similar to “at least one of A, B and C” are intended to be interpreted in the conjunctive, i.e., to require at least one of A, at least one of B and at least one of C unless stated or implied by context otherwise. Further still, the term “substantially” or similar words requiring subjective comparison are intended to mean “within manufacturing tolerances” unless stated or implied by context otherwise.

As used herein, the terms “coupled,” “attached,” “connected,” or “operatively connected” can be used herein to refer to any type of relationship, direct or indirect, between the components in question. For example, the terms “coupled,” “attached,” “connected,” or “operatively connected” may refer to at least a functional relationship between two elements and may encompass configurations in which the two elements are directed connected to each other, i.e., without any intervening elements, or indirectly connected to each other, i.e., with intervening elements. Additionally, the terms “first,” “second,” etc. are used herein only to facilitate discussion, and carry no particular temporal or chronological significance unless otherwise indicated. The terms “cause” or “causing” means to make, force, compel, direct, command, instruct, and/or enable an event or action to occur or at least be in a state where such event or action can occur, either in a direct or indirect manner.

Although a number of illustrative examples are described herein, it should be understood that numerous other modifications and examples can be devised by those skilled in the art that will fall within the spirit and scope of the principles of the foregoing disclosure. More particularly, reasonable variations and modifications are possible in the component parts and/or arrangements of the subject combination arrangement within the scope of the foregoing disclosure, the drawings and the appended claims without departing from the spirit of the foregoing disclosure. In addition to variations and modifications in the component parts and/or arrangements, alternative uses will also be apparent to those skilled in the art. The examples can be combined to form additional examples.

What is claimed is:

1. A journal bearing, comprising:
a main body, the main body having an inner surface defining a shaft bore and an outer surface positioned at a distance from the inner surface;
an end surface extending radially between the inner surface and the outer surface; and
a relief groove formed in the end surface.

2. The journal bearing of claim 1, wherein the relief groove has a curved shape.

3. The journal bearing of claim 1, wherein the end surface has a corner edge at a junction with the inner surface, wherein the relief groove is located adjacent the corner edge.

4. The journal bearing of claim 1, wherein the journal bearing is a partial cylinder, and wherein the relief groove extends across an entirety of the end surface.

5. The journal bearing of claim 1, wherein the journal bearing is a complete cylinder, and wherein the relief groove extends across only a portion of the end surface.

6. A journal bearing, comprising:
a main body, the main body having an inner surface defining a shaft bore and an outer surface positioned at a distance from the inner surface;
an end surface extending radially between the inner surface and the outer surface; and
a relief flange formed on the end surface.

7. The journal bearing of claim 6, wherein the relief flange has a collar shape extending from the end surface.

8. The journal bearing of claim 6, wherein the relief flange is located to define a portion of the shaft bore.

9. The journal bearing of claim 6, wherein the journal bearing is a partial cylinder, and wherein the relief flange extends across an entirety of the end surface.

10. The journal bearing of claim 6, wherein the journal bearing is a complete cylinder, and wherein the relief flange extends across only a portion of the end surface.

11. A journal bearing for mounting on a shaft, the journal bearing comprising:
a main body having an inner surface defining a shaft bore and a lateral end surface extending radially from the inner surface; and
a relief complaint edge feature formed at the lateral end surface.

12. The journal bearing of claim 11, wherein the relief complaint edge feature is a relief groove.

13. The journal bearing of claim 12, wherein the relief groove has a curved shape.

14. The journal bearing of claim 12, wherein the journal bearing is a partial cylinder, and wherein the relief groove extends across an entirety of the lateral end surface.

15. The journal bearing of claim 12, wherein the journal bearing is a complete cylinder, and wherein the relief groove extends across only a portion of the lateral end surface.

16. The journal bearing of claim 11, wherein the relief complaint edge feature is a relief flange.

17. The journal bearing of claim 16, wherein the relief flange has a collar shape extending from the lateral end surface.

18. The journal bearing of claim 16, wherein the journal bearing is a partial cylinder, and wherein the relief flange extends across an entirety of the lateral end surface.

19. The journal bearing of claim 16, wherein the journal bearing is a complete cylinder, and wherein the relief flange extends across only a portion of the lateral end surface.

20. An internal combustion engine comprising a rocker arm disposed about a journal of a rocker shaft, and further comprising the journal bearing of claim 11 disposed between the rocker arm and journal.
